(19) United States
(12) Patent Application Publication
(10) Pub. No.: US 2016/0257886 A1
(43) Pub. Date: Sep. 8, 2016

(54) Flame Retardent Compositions and Apparatus for Electric Vehicle Battery Systems

(71) Applicant: Frank Tiberius Gangi, Brookline, MA (US)

(72) Inventor: Frank Tiberius Gangi, Brookline, MA (US)

(21) Appl. No.: 14/593,737

(22) Filed: Jan. 9, 2015

Related U.S. Application Data
(60) Provisional application No. 61/925,327, filed on Jan. 9, 2014.

(51) Int. Cl. C09K 21/14; C09K 21/08

(52) U.S. Cl. CPC C09K 21/14; C09K 21/08

(57) ABSTRACT

The fluid in a liquid thermal management system for an electric vehicle battery includes a flame retardant to reduce the potential fire hazard posed by the battery. The battery is for example a lithium ion battery. The flame retardant is, for example, a bromine compound. In some embodiments, the flame retardant is microencapsulated.

### BACKGROUND

Electric vehicles, such as electric cars generally include a battery or batteries for power. A number of types of rechargeable batteries are used in electric vehicle applications. In particular, lithium ion batteries are used in electric vehicles because they are generally light in weight while having favorable energy and power densities and high charge and discharge efficiencies. Lithium-ion batteries and other types of batteries can pose fire hazards, typically from punctures but also from improper charging. Attempts to reduce fire risk have involved varying the battery chemistry which also typically reduces the battery's energy and power densities.

It remains desirable to have a method and apparatus for reducing the battery-related fire risks in electric vehicles.

### SUMMARY

The present invention is directed to flame retardant compositions and devices for electric vehicle battery systems.

Electric vehicle battery systems suitable for use with the flame retardant compositions according to embodiments of the invention are liquid thermal management systems. The thermal fluid in these systems includes a flame retardant. The flame retardant acts to reduce fire hazard in the event of a battery charging problem or a battery puncture. The flame retardants added to the thermal fluid include, for example, bromine compounds. In some embodiments, the thermal fluid includes an encapsulated flame retardant.

The present invention together with the above and other advantages may best be understood from the following detailed description of the embodiments of the invention illustrated in the drawings, wherein:

### DRAWINGS

FIG. 1 is an illustration of an electric vehicle battery pack in a liquid thermal management system according to principles of the invention.

### DESCRIPTION

Embodiments of the present invention include flame retardant compositions and apparatus for reducing the fire hazard of electric vehicle batteries. In one embodiment, the fluid in a liquid thermal management system for an electric vehicle battery includes a flame retardant in its composition. In another embodiment, the fluid in the liquid thermal management system includes a micro-encapsulated flame retardant.

There are a variety of battery pack designs for electric vehicles. Typically a battery pack includes a number of discrete cells connected in series or in parallel. In some designs, cells are grouped in modules which are arranged inside a battery pack. Various battery pack designs may include battery management systems with sensors for temperature, voltage and current and data communications mechanisms. A battery pack in an electric vehicle typically operates in the temperature range of −20 C. to 60 C.

Microencapsulation is a process in which tiny amounts of a substance, such as a flame retardant liquid, are surrounded by a coating. The resulting microcapsule has useful properties such as reduction of degradation of the contained substance. Microencapsulation also protects the properties provided by the elements of a composition from the contained substance.

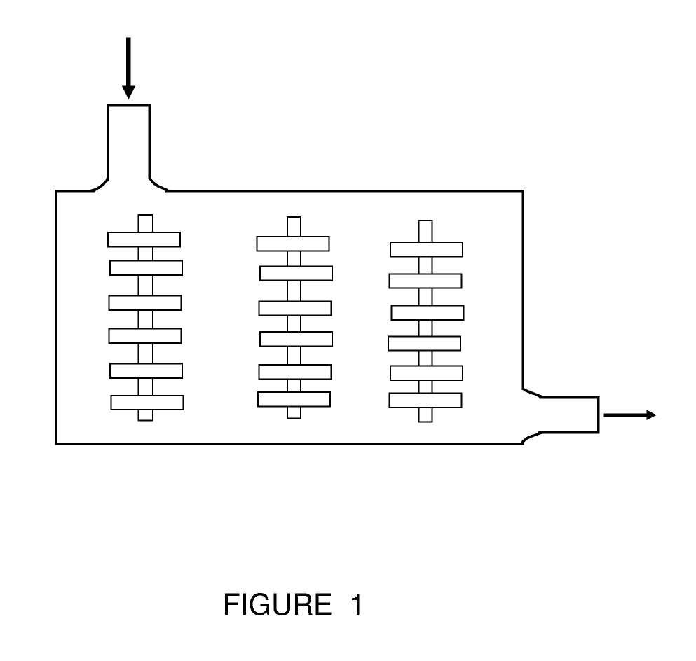

FIG. 1 is an illustration of a battery pack in a liquid thermal management system suitable for using flame-retardant compositions according to embodiments of the invention. The battery pack has a number of modules. The battery pack is located in a container having an inlet and an outlet for the thermal fluid. In a first embodiment, the cells in the battery pack are lithium ion batteries. In an alternative embodiment, the cells in the battery pack are lithium polymer batteries. One of ordinary skill in the art will understand that other types of batteries may be used in the battery pack in embodiments of the present invention.

The thermal fluid in a first embodiment is a composition of water, a glycol compound and a flame retardant. The glycol compound is colloquially referred to as “antifreeze”. Common glycol compounds used for this purpose are ethylene glycol, diethylene glycol and propylene glycol. The thermal fluid composition in embodiments of the present invention further includes a flame retardant. A typical composition for thermal fluid includes 50% by volume of water and 50% by volume of glycol. The present thermal fluid further, for example, includes ½% by weight of flame retardant. Other compositions are possible within the scope of the invention.

A flame retardant is a compound that inhibits, suppresses or delays the production of flames or prevents the spread of fire. The flame retardant in embodiments of the invention is, for example, a bromine compound, either a brominating agent or a reactive solvent. Example bromine compounds include decabromodiphenyl (decaBDE), decabromodiphenyl ethane, polymeric brominated compounds such as brominated polystyrenes, brominated carbonate oligomers (BCOs), brominated epoxy oligomers (BEOs), tetrabromophthalic anyhydride, tetrabromobisphenal A (TBBPA), and hexabromocyclododecane (HBCD). Additional examples of bromine compounds suitable for use as flame retardants in the thermal fluid composition include phosphorus tribromide (PBr.sub.3), thionyl bromide (SOBr.sub.2), boron tribromide (BBr.sub.3), silicon tetrabromide (SiBr.sub.4), titanium tetra-bromide (TiBr.sub.4), iodine bromide (TBr), phosphorous oxy-bromide (POBr.sub.3), bromine trifluoride (BrF.sub.3), bromine pentafluoride (BrF.sub.5), N-bromosuccinimide (C.sub.4H.sub.40.sub.2NBr), nitrosyl bromide (NOBr), chlorine bromide (ClBr), cuprous bromide (CuBr), lithium bromide (LiBr, m.p. 547.degree. C.), calcium bromide (CaBr.sub.2, m.p. 730.degree. C.), and chromous bromide (CrBr.sub.2, m.p. 842.degree. C.). Other compositions of thermal fluids and flame retardants are possible within the scope of the invention.

In some embodiments, the flame retardant is microencapsulated. The microencapsulation material in one embodiment is high density polyethylene (HDPE). HDPE typically fractures at temperatures between 120 C.-180 C. Microencapsulating the flame retardant protects properties of the thermal fluid such as viscosity.

In operation, as the battery is called upon to power the electric vehicle, the battery heats up. The thermal fluid flows through the container and over the modules of the battery. In the event of an overcharge, or a car accident resulting in a battery puncture, the flame retardant in the thermal fluid acts to reduce the fire hazard.

In the embodiments having microencapsulated flame retardant, the microcapsules fracture when fracture temperature is reached because of excess heat due, for example to fire. The flame retardant is released from the microcapsules and acts to bring the fire under control.

It is to be understood that the above-identified embodiments are simply illustrative of the principles of the invention. Various and other modifications and changes may be made by those skilled in the art which will embody the principles of the invention and fall within the spirit and scope thereof.

We claim:

1. A flame retardant composition for an electric vehicle battery system, comprising:
water;
a glycol; and
a flame retardant microencapsulated in high density polyethylene.

2. The flame retardant composition of claim 1 wherein the flame retardant is a bromine compound.

3. The flame retardant composition of claim 2 wherein the bromine compound is selected from the group consisting of decabromodiphenyl (decaBDE), decabromodiphenyl ethane, polymeric brominated compounds, brominated carbonate oligomers (BCOs), brominated epoxy oligomers (BEOs), tetrabromophthalic anyhydride, tetrabromobisphenal A (TBBPA), and hexabromocyclododecane (HBCD), phosphorus tribromide (PBr.sub.3), thionyl bromide (SOBr.sub.2), boron tribromide (BBr.sub.3), silicon tetrabromide (SiBr.sub.4), titanium tetra-bromide (TiBr.sub.4), iodine bromide (TBr), phosphorous oxy-bromide (POBr.sub.3), bromine trifluoride (BrF.sub.3), bromine pentafluoride (BrF.sub.5), N-bromosuccinimide (C.sub.4H.sub.40.sub.2NBr), nitrosyl bromide (NOBr), chlorine bromide (ClBr), cuprous bromide (CuBr), lithium bromide (LiBr), calcium bromide (CaBr.sub.2), and chromous bromide (CrBr.sub.2).

4. The flame retardant composition of claim 2 wherein the bromine compound is a brominated polystyrene.

5. The flame retardant composition of claim 1 wherein the flame retardant is microencapsulated.

6. (canceled)
